(19) United States
(12) Patent Application Publication
(10) Pub. No.: US 2012/0018633 A1
(43) Pub. Date: Jan. 26, 2012

(54) RADIATION IMAGE DETECTING CASSETTE

(75) Inventor: Shigeru Aoyagi, Tokyo (JP)

(73) Assignee: KONICA MINOLTA MEDICAL & GRAPHIC, INC., Hino-shi, Tokyo (JP)

(21) Appl. No.: 13/262,045

(22) PCT Filed: Feb. 5, 2010
(86) PCT No.: PCT/JP2010/051689

§ 371 Date: Sep. 29, 2011

(30) Foreign Application Priority Data
Apr. 10, 2009 (JP) 2009-095698

(51) Int. Cl. G01T 1/16

(52) U.S. Cl. 250/336.1

(57) ABSTRACT

Disclosed is a radiation image detecting cassette, which makes it possible to continuously conduct operations for detecting appropriate radiation images without making the glass substrate fall into the breakage failure. The cassette includes: a detecting section to detects radiation being incident thereon; a glass base plate onto which the detecting section is installed; a substrate to support the glass base plate; a housing that incorporates the detecting section, the glass base plate and the substrate, therein; and a buffer member that is installed between an end portion of the substrate and an inner wall of the housing. A side wall is formed at the end portion of the substrate, and the glass base plate is supported by the substrate in such a state that the glass base plate is adhered onto the substrate. A gap is provided between an end portion of the glass base plate and the side wall.

### CROSS REFERENCE TO RELATED APPLICATIONS

This is a U.S. national stage of application No. PCT/JP2010/051689, filed on Feb. 5, 2010. Priority under 35 U.S.C. §119(a) and 35 U.S.C. §365(b) is claimed from Japanese Application No. 2009-095698, filed Apr. 10, 2009, the disclosure of which is also incorporated herein by reference.

### FIELD OF THE INVENTION

The present invention relates to a radiation image detecting cassette.

### TECHNICAL BACKGROUND

In recent years, a digital-type radiation image detecting apparatus has been increasingly employed as a method for irradiating radiation onto a subject and detecting the radiation penetrated through the subject so as to acquire a radiation image of the subject. The FPD (Flat Panel Detector) can be cited as the digital-type radiation image detecting apparatus abovementioned.

Exemplified as the FPD is such that a plurality of detecting elements are two-dimensionally arranged on a substrate, and the radiation penetrated through the subject are irradiated onto a phosphor member (scintillator) to convert visual light, emitted from the phosphor member in response to the amount of irradiated radiation, to electric charge to be accumulated into a photo-electric conversion element, and then, the electric charge accumulated into the photo-electric conversion element is read out so as to acquire the radiation image concerned. The FPD as abovementioned has such an instantaneous radiographic capability that makes it possible to obtain the radiation image immediately after the image capturing operation has been completed.

FIG. 9 shows a schematic diagram indicating a vertical cross sectional view of the cassette-type FPD500. The structure of the cassette-type FPD500 shown in FIG. 9 is set forth in Tokkai 2001-346788 (Japanese Patent Application Laid-Open Publication).

A base plate A2 is incorporated into a housing A1, and a radiation detecting section B0 is mounted above the base plate A2. The radiation detecting section B is constituted by integrally laminating various kinds of functional layers, including a glass substrate B1 made of a glass material, a photo-electric conversion element B2 formed in a two-dimensional arrangement structure through a semiconductor fabricating process, and a phosphor plate B3 formed by coating a phosphor material made of metallic compound onto a resin plate, with each other. A circuit board A3 onto which various kinds of electronic parts for processing the electric signals, acquired as a result of the photo-electronic converting actions, is fixed onto the lower surface of the base plate A2, while placing protrusions A4 between them. Further, the circuit board A3 and the photo-electric conversion element B2 are coupled to each other through a flexible circuit board A5.

Since the cassette-type FPD500 shown in FIG. 9 is such a portable-type cassette that is to be brought into a predetermined place to employ it for conducting the radiation image capturing operation, sometimes, an operator would erroneously drop the cassette-type FPD500 in mid-course of conveying it into the predetermined place, or accidentally make it collide with another object, and as a result, an unexpected impact would be incurred to the cassette-type FPD500 from its side wall, as indicated by the white bold arrows shown in FIG. 9. For instance, an absence of any countermeasure for the abovementioned impact causes the breakage failure of the glass substrate B1 equipped on the base plate A2, as a result of the collision between the base plate A2, etc., residing in the housing A1, and the inner surface of the housing A1, when the unexpected impact is applied onto the cassette-type FPD500. To cope with such the unexpected impact, the cassette-type FPD500 set forth in Tokkai 2001-346788 is provided with a buffer member A6 that absorbs the impact force to be incurred to the base plate A2, etc., disposed inside the housing A1, so as to prevent the base plate A2, etc., from falling into disrepair even if the unexpected impact is applied onto the cassette-type FPD500.

### SUMMARY OF THE INVENTION

To overcome the abovementioned drawbacks in conventional cassette type radiation image detectors, it is one of objects of the present invention to provide a radiation image detecting cassette, which makes it possible to prevent a glass substrate from falling into the breakage failure caused by the impact to be applied from the outside environment.

Accordingly, at least one of the objects of the present invention can be attained by any one of the cassette type radiation image detectors described as follows.

(1) According to a radiation image detecting cassette reflecting an aspect of the present invention, the radiation image detecting cassette that detects radiation irradiated onto a subject to acquire radiation image data, and that is formed as a portable-type cassette, comprises: a detecting section to detects radiation being incident thereon, so as to output electric signals corresponding to incident radiation detected; a glass base plate onto which the detecting section is installed; a substrate to support the glass base plate; a housing that incorporates at least the detecting section, the glass base plate and the substrate, therein; and a buffer member that is installed between an end portion of the substrate and an inner wall of the housing; wherein a side wall is formed at the end portion of the substrate, and the glass base plate is supported by the substrate in such a state that the glass base plate is adhered onto the substrate; and wherein a gap is provided between an end portion of the glass base plate and the side wall.
(2) According to another aspect of the present invention, in the radiation image detecting cassette recited in item 1, a width of the gap is set at 1 mm.
(3) According to still another aspect of the present invention, in the radiation image detecting cassette recited in item 1, a buffer member is inserted between the glass base plate and the substrate.
(4) According to still another aspect of the present invention, in the radiation image detecting cassette recited in any one of items 1-3, when it is defined that an outer-shape length of the housing is “A” and a detecting-region length of the radiation image detecting cassette in the same direction of the concerned outer-shape length is “B”, a value of B/A is in a range of 0.85˜0.95.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a perspective view of a cassette type detector;

FIG. 2 shows an exploded perspective view of a housing;

FIG. 3 shows a cross sectional view of a cassette type detector shown in FIG. 1, when viewing it from a direction indicated by an arrow “a” at a predetermined position;

FIG. 4 shows an enlarged schematic diagram of an X region shown in FIG. 3;

FIG. 5 shows an explanatory schematic diagram indicating a rough setup by which experiments of dropping a cassette type detector are to be implemented;

FIG. 6 shows a schematic diagram indicating a glass base plate and a substrate as another embodiment of the present invention;

FIG. 7 shows a schematic diagram indicating a glass base plate and a substrate as still another embodiment of the present invention;

FIG. 8 shows a block diagram indicating a configuration of a cassette type detector; and

FIG. 9 shows a schematic diagram indicating a vertical cross sectional view of a conventional cassette type FPD.

### DETAILED DESCRIPTION OF THE PREFERRED EMBODIMENT

### <Summary of Cassette Type Detector>

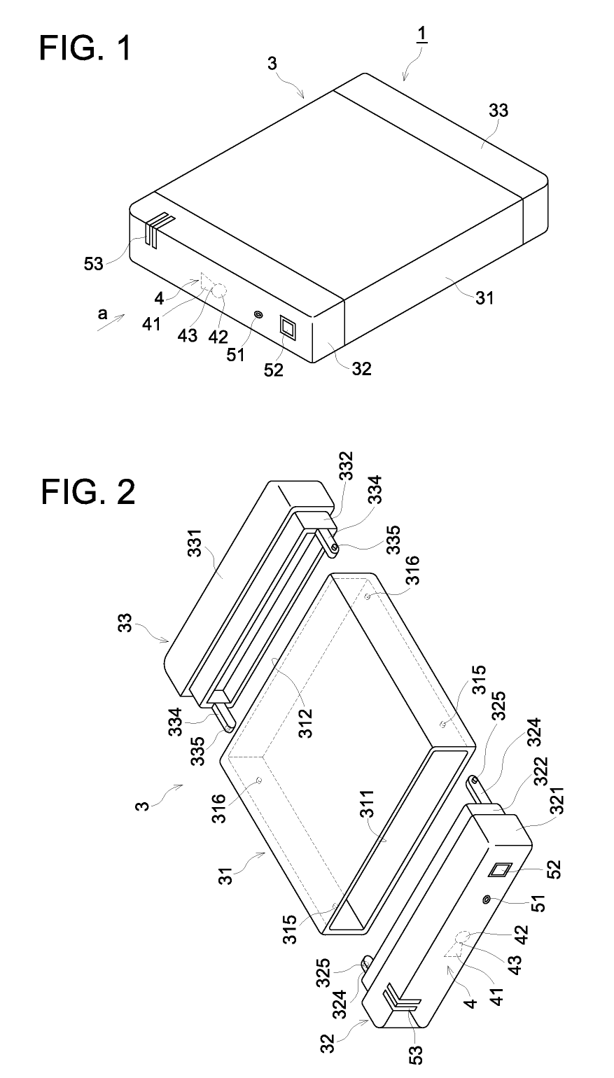

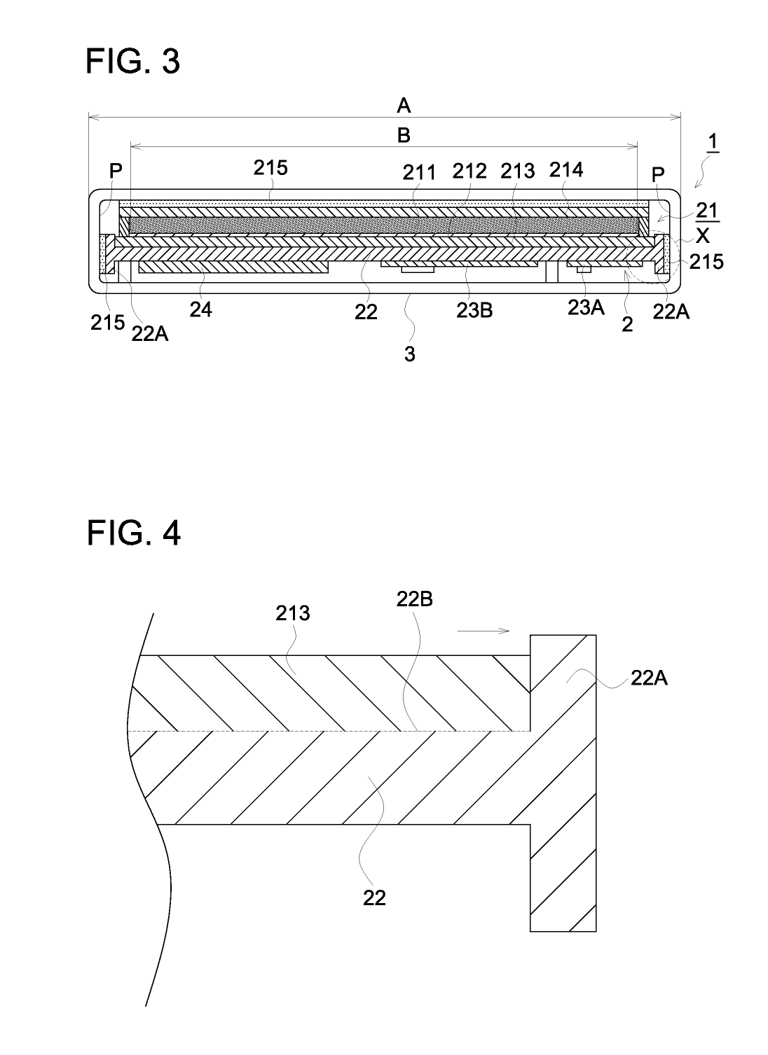

FIG. 1 shows a perspective view of a cassette type detector. A cassette type detector 1 that serves as a cassette type radiation image detector, is defined as a cassette type FPD (Flat Panel Detector). The cassette type detector 1 is provided with a radiation detecting section 2 that detects the radiation irradiated and penetrated through the subject so as to acquire radiation image information as digital image data (refer to FIG. 3), and a housing 3 that accommodates the radiation detecting section 2 therein.

In the present embodiment, the housing 3 is formed in such a shape that the thickness of the housing 3 in an incident direction of the radiation is equal to 15 mm. In this connection, it is preferable that the thickness of the housing 3 in an incident direction of the radiation is equal to or smaller than 16 mm, and it is also preferable that the concerned thickness is in a range of the size in conformity with the sizes specified by the standard (JIS (Japan Industrial Standard) Z4905 for the cassette to be used for conventional screens and films (namely, in a range of (15 mm+1 mm)−(15 mm−2 mm)). Incidentally, the international standard that corresponds to JIS Z4905 is IEC 60406.

FIG. 2 shows an exploded perspective view of a housing 3. As shown in FIG. 2, the housing 3 is provided with a housing main section 31 that is formed in a rectangular hollow cylinder having an opening 311 and another opening 312 at both end portions thereof, and a first covering member 32 and a second covering member 33 that cover the opening 311 and the other opening 312, respectively.

The housing main section 31 is made of a carbon fiber material (for instance, a CFRP (Carbon Fiber Reinforced Plastic)), so as to form it in a lightweight and a superior strength body. The thickness of the housing main section 31 is formed in a cylindrical shape, so as to maintain the strength of the cassette type detector 1.

The first covering member 32 and the second covering member 33 are provided with a covering main section 321 and another covering main section 331, and an insertion section 322 and another insertion section 332, respectively, which are made of an aluminum material.

As shown in FIG. 2, connecting extensions 324 and other connecting extensions 334, serving as connecting members for connecting the housing main section 31 with the first covering member 32 and the second covering member 33, are extended towards the inserting directions against the opening 311 and the other opening 312, respectively. Further, engagement protrusions 325 and other engagement protrusions 335 are formed onto the outer surfaces of the connecting extensions 324 and the connecting extensions 334, respectively. When the first covering member 32 and the second covering member 33 are inserted into the housing main section 31, the engagement protrusions 325 and the other engagement protrusions 335 are engaged with engagement dent sections 315 and 316, respectively.

A wireless communicating section 4, to be used for bilaterally communicating information in a wireless communication mode between the cassette type detector 1 and an external apparatus, is embedded into a surface, which is one of side surfaces of the covering main section 321 of the first covering member 32. The wireless communicating section 4 is constituted by a pair of a radio plate 41 and another radio plate 42, and a power feeding section 43 that feeds electric signal power to drive the pair of radio plates 41, 42.

Further, on the surface same as one of the surfaces of the covering main section 321, into which the wireless communicating section 4 is embedded, a charging terminal 51, to which an external power source or the like is to be coupled when a rechargeable buttery 24 (refer to FIG. 3), mounted inside the housing 3, is to be recharged, is provided, and, in addition, an electric power switch 52, for turning ON or OFF the electric power supply to be fed to the cassette type detector 1 from the electric power source, is disposed. Still further, an indicator 53, which is constituted by, for instance, a LED (Light Emitting Diode) or the like so as to indicate the charging status of the rechargeable buttery 24, various kinds of operating statuses, etc., at the corner section formed by the surface into which the wireless communicating section 4 is embedded and the other surface of radiation incident side.

### <Internal Structure of Cassette Type Detector>

Next, an internal structure of the cassette type detector 1 will be detailed in the following. FIG. 1 shows a schematic diagram indicating a cross sectional view at a predetermined position, when viewing the cassette type detector 1 shown in FIG. 1 from a direction indicated by the arrow “a”.

As shown in FIG. 3, a radiation detecting section 2 is constituted by a detecting unit 21, a substrate 22, and various kinds of electric parts (such as a relay circuit board 23A, a control circuit board 23B, the rechargeable buttery 24 (for instance, a lithium in capacitor, etc.), etc). In the present embodiment, the substrate 22 is supported on the upper surface of the substrate 22, while, the various kinds of electric parts including the control circuit board 23B, the rechargeable buttery 24, etc., are mounted onto the lower surface of the substrate 22.

The substrate 22 is flexible and made of a resin material. The material of the substrate 22 is such a resin material that is formed as a mixture of Polycarbonate and ABS (Acrylonitrile Butadiene Styrene). The substrate 22 supports a glass base plate 213, while a thin lead layer (not shown in FIG. 3) is placed between the substrate 22 and the glass base plate 213.

The detecting unit 21 is constituted by: a scintillator 211, a detecting section 212, the glass base plate 213, an opposing base plate 214, etc. Concretely speaking with respect to the fundamental structure of the detecting unit 21, the detecting section 212 is mounted over the glass base plate 213, and the scintillator 211 is mounted over the glass base plate 213. Further, the opposing base plate 214 is mounted onto the upper side of the scintillator 211, so that the scintillator 211 is tightly clipped by the opposing base plate 214 and the glass base plate 213. The thickness of each of the opposing base plate 214 and the glass base plate 213 is set at, for instance, about 0.6 mm.

The scintillator 211 has a function for converting the incident radiation to light. For instance, the scintillator 211 includes a fluorescent substance as its main gradient, so as to output (emit an electro-magnetic wave, the wavelengh of which is in a range of 300-800 nm, namely, the electro-magnetic wave (light) representing a light from a violet color light to an infreared light in center of visible light, based on the incident radiation.

The detecting section 212 converts the electromagnetic wave (light) outputted from the scintillator 211 to an electric energy so as to store the converted electric energy therein, and then outputs electric signals based on the electric energy stored. The electric signals generated by the detecting section 212 are transferred to the first relay circuit board 23A through a flexible harness (not shown in the drawings).

Buffer members 215 are installed into gaps formed between the end portions of the substrate 22 and inside surfaces P of the housing 3, and on the upper side of the opposing base plate 214, respectively.

As described in the foregoing, by employing the cassette type detector 1 indicated by the schematic diagrams shown in FIG. 1 through FIG. 3, it becomes possible to detect (capture) the radiation image of the subject.

### <Breakage Prevention of Glass Base Plate>

Next, a structure in regard to the breakage prevention of glass base plate 213 will be detailed in the following.

the cassette type detector 1, indicated by the schematic diagrams shown in FIG. 1 through FIG. 3, is so constituted that its dimensional sizes are in conformity with those specified by the standard (Japan Industrial Standard) for the cassette to be used for conventional screens and films in order to make it possible to employ it for an existing equipment (such as a bucky table, etc.).

A symbol “A” shown in FIG. 3 represents a length of an outer shape of the housing 3 (hereinafter, referred to as an outer shape length A), while a symbol “B” shown in FIG. 3 represents a length of the radiation detecting area of the cassette type detector 1 (hereinafter, referred to as a detecting length B) in the same direction as that of the outer shape length “A” (in other words, the direction of measuring the detecting length B is the same as the direction of measuring the outer shape length A). In the present embodiment, the ratio of (detecting length B)/(outer shape length A) is set at 0.95, while, in the cassette-type detector formed as the standard size, the ratio of (detecting length B)/(outer shape length A) is set at a value in a range of 0.85-0.95. Accordingly, since the radiation detecting area of the cassette-type detector formed as the standard size occupies a very large area in respect to the total outer shape area of the housing 3, a little space remains for forming each of gaps between the edge portions of the detecting section 212 and glass base plate 213, and inner sides P of the housing 3 (refer to FIG. 3). Accordingly, it has been impossible to sufficiently install a buffer member 215 into each of gaps between the edge portions of the detecting section 212 and glass base plate 213, and the inner sides P of the housing 3.

To overcome the abovementioned problem, the cassette type detector 1 embodied in the present invention is provided with a side wall 22A formed at the end portion of the substrate 22. Since the contact area between the substrate 22 and the buffer member 215 can be widened by forming the side wall 22A as shown in FIG. 3, the unexpected impact to be applied to the substrate 22 from the side direction (left-right direction in FIG. 3) can be alleviated, even if the thickness of the buffer member 215 is thin, and as a result, it becomes possible to prevent the glass base plate 213 from the breakage failure. Further, even when the side wall 22A is formed at the end portion of the substrate 22, the thickness of the substrate 22 at the area onto which the control circuit board 23B is to be mounted, as shown in FIG. 3, is not getting thick, and accordingly, it also becomes possible to make the outer shape of the cassette type detector 1 thinner than ever.

Further, when the unexpected impact is applied to the housing 3 from the side direction (left-right direction in FIG. 3), for instance, in such a state that the glass base plate 213 is simply placed on the substrate 22 without being fixed onto substrate 22, the breakage failure would possibly occur at the end portion of the glass base plate 213, even if the unexpected impact to be applied to the substrate 22 is alleviated by the combination of the side wall 22A and the buffer member 215. Referring to the schematic diagram shown in FIG. 4, this point will be detailed in the following.

FIG. 4 shows an enlarged schematic diagram of the X region shown in FIG. 3 (surrounded by the circle depicted by the broken line) indicating only the substrate 22 and the glass base plate 213. The side wall 22A of the substrate 22 is formed at the end portion of the glass base plate 213. Although a double-faced adhesive tape 22B, detailed later, is inserted between the substrate 22 and the glass base plate 213 in the structure shown in FIG. 4, when it is assumed such a case that the double-faced adhesive tape 22B is not inserted and the glass base plate 213 is simply placed on the substrate 22 without being fixed onto the substrate 22, and the unexpected impact is applied to the housing 3 from the side direction, the glass base plate 213 is forcibly shifted in the direction indicated by the arrow shown in FIG. 4 so that the end portion of the glass base plate 213 collides with the side wall 22A of the substrate 22, and as a result, the breakage failure would possibly occur at the end portion of the glass base plate 213, even if the unexpected impact to be applied to the substrate 22 can be alleviated.

To cope with such the case as abovementioned, the glass base plate 213, to be employed in the structure embodied in the present invention, is supported in a state that the glass base plate 213 is adhered onto the substrate 22. As shown in FIG. 4, the double-faced adhesive tape 22B (thickness is in a range of about 0.1-0.2 mm), indicated by the broken line, is inserted between them, so as to adhere the glass base plate 213 and the substrate 22 to each other. Concretely speaking, as aforementioned, the thin lead layer (not shown in the drawings) is coated on the substrate 22, and the double-faced adhesive tape 22B is applied on the lead layer so as to adhere the glass base plate 213 and the substrate 22 to each other. Anyway, any kind of adhering method is applicable for adhering them to each other as far as the glass base plate 213 is supported in such a state that the glass base plate 213 is adhered onto the substrate 22 (for instance, a kind of adhering agent, instead of the double-faced adhesive tape, is also applicable for adhering them to each other).

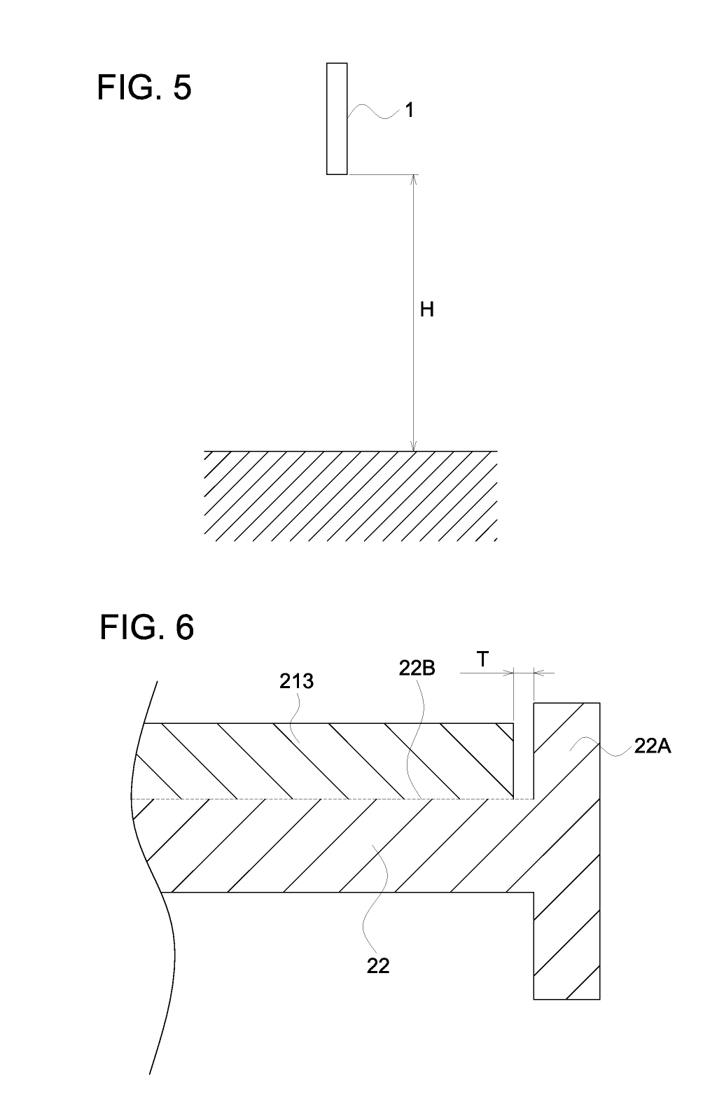

The present inventors have compared the case that the cassette type detector 1 is structured in such a manner that the glass base plate 213 is simply placed on the substrate 22 without being fixed onto the substrate 22 with the other case that the cassette type detector 1 is structured in such a manner that the glass base plate 213 is supported by the substrate 22 in the state that the glass base plate 213 is adhered onto the glass base plate 213, so as to confirm the frequency ratio of breakage failure occurrences of the glass base plate 213, when the unexpected impact is applied to the cassette type detector 1, through the experiments described as follows. In the experiments, as indicated in the schematic diagram shown in FIG. 5, the cassette type detector 1 has been sequentially dropped from a height H (representing a height from which the cassette type detector 1 would be possibly dropped during an actual situation in which an operator is conveying the concerned cassette) for plural times, so as to confirm the frequency ratio of breakage failure occurrences of the glass base plate 213.

With respect to the cassette type detector 1 structured in such a manner that the glass base plate 213 is simply placed on the substrate 22 without being fixed onto the substrate 22, when it has been dropped from the height H of 60 cm, the glass base plate 213 has broken three times among six dropping trials. Further, when it has been dropped from the height H of 75 cm, the glass base plate 213 has broken four times among six dropping trials, while, when it has been dropped from the height H of 90 cm, the glass base plate 213 has broken six times among six dropping trials. On the other hand, with respect to the cassette type detector 1 structured in such a manner that the glass base plate 213 is supported by the substrate 22 in the state that the glass base plate 213 is adhered onto the glass base plate 213, the glass base plate 213 has not at all broken, even when it has been dropped from any one of the abovementioned heights H.

As found from the abovementioned experiments, by forming the side wall 22A at the end portion of the substrate 22 so as to widen the contact area between the substrate 22 and the buffer member 215, and by adhering the glass base plate 213 to the substrate 22, it becomes possible to continuously conduct the appropriate operations for detecting the radiation image without making the glass base plate 213 to be broken by the impact force applied from the outside. Specifically, the present invention is very effective for the standard sized cassette type detector in which only a little space is available for inserting the buffer member.

FIG. 6 shows a schematic diagram indicating another embodiment of the present invention. According to the embodiment shown in FIG. 4, the end portion of the glass base plate 213 is made to tightly contact to the side wall 22A of the substrate 22, without setting any gap between the end portion of the glass base plate 213 and the side wall 22A. On the other hand, in the other embodiment shown in FIG. 6, a gap T (about 1 mm) is set between the end portion of the glass base plate 213 and the side wall 22A. Further, in the other embodiment shown in FIG. 6, the glass base plate 213 and the substrate 22 are adhered to each other by employing the double-faced adhesive tape 22B as well as the embodiment shown in FIG. 4.

Provided that the glass base plate 213 and the substrate 22 are adhered to each other even if no gap is set between the end portion of the glass base plate 213 and the side wall 22A, as described by referring to the embodiment shown in FIG. 4, the glass base plate 213 is not shifted by the unexpected impact, and the end portion of the glass base plate 213 does not collide with the side wall 22A of the substrate 22, and accordingly, the glass base plate 213 is not broken by the unexpected impact applied to the cassette type detector 1. However, according to the other embodiment in which the glass base plate 213 and the substrate 22 are adhered to each other and the gap T is set between the end portion of the glass base plate 213 and the side wall 22A, even if a considerably strong impact force is applied to the cassette type detector 1 to such an extent that the glass base plate 213 is forcibly shifted to a certain degree toward the side wall 22A of the substrate 22, the end portion of the glass base plate 213 does never collide with the side wall 22A of the substrate 22, and the glass base plate 213 never be broken. In other words, by setting the gap T between the end portion of the glass base plate 213 and the side wall 22A, it becomes possible to prevent the glass base plate 213 from being broken by the considerably strong impact force applied to the cassette type detector 1, more effectively than ever.

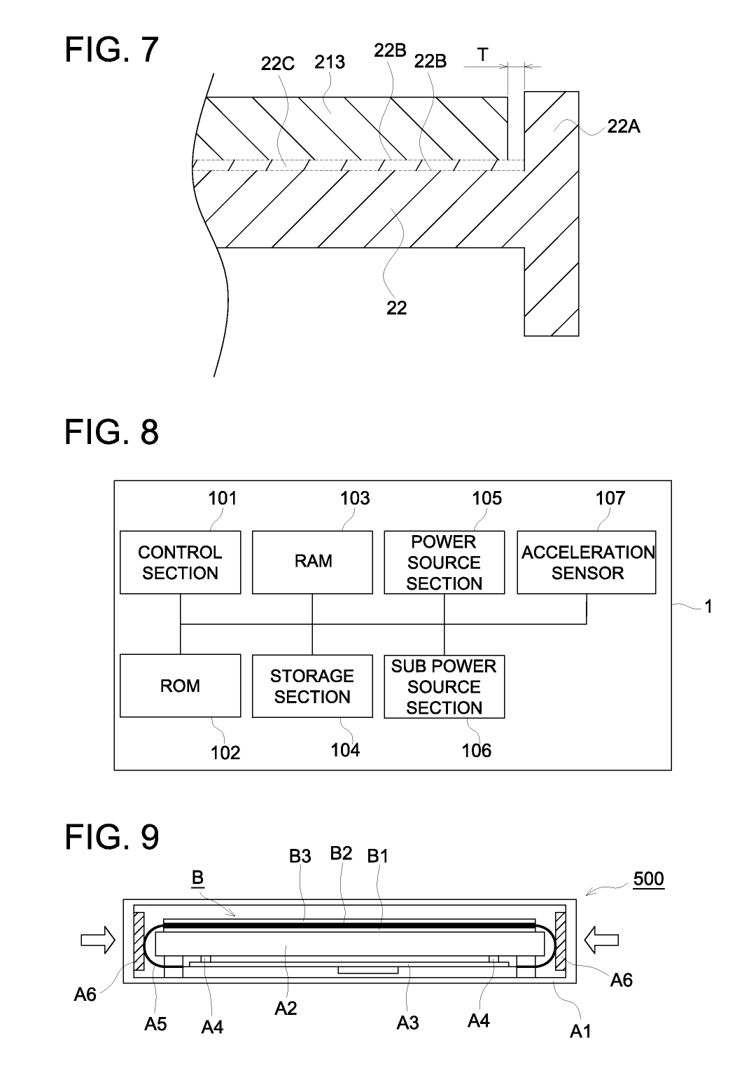

FIG. 7 shows a schematic diagram indicating still another embodiment of the present invention. According to the embodiment shown in FIG. 7, a buffer member 22C for dispersing a load or the like to be applied onto the cassette type detector 1, on such an occasion that a patient lies on the cassette type detector 1 at the time of detecting the radiation image of the patient concerned, is inserted between the glass base plate 213 and the substrate 22. The buffer member 22C is made of a foamed polyethylene material or the like, and has a thickness being in a range of about 0.5˜1.0 mm. Further, the double-faced adhesive tape 22B is employed for making the buffer member 22C adhere not only to the detecting unit 21, but also to the substrate 22.

Although the load to be applied to the glass base plate 213, etc., can be dispersed by inserting the buffer member 22C, the glass base plate 213 is liable to shift relative to the substrate 22 when the unexpected impact is applied to the cassette type detector 1 from the side direction. To overcome such the drawback, by inserting the buffer member 22C, and in addition, by setting the gap T between the end portion of the glass base plate 213 and the side wall 22A, it becomes possible to satisfy both of dispersing the load applied to the glass base plate 213 and preventing the glass base plate 213 from breaking.

### <Management of Degree of Impact to be Applied to Cassette Type Detector and Frequency Number Thereof>

As aforementioned, sometimes, a user would erroneously drop the cassette type detector 1 in mid-course of conveying it into the predetermined place, or accidentally make it collide with another object, and as a result, an unexpected impact would be incurred to the cassette type detector 1. Further, after an unexpected impact has been incurred to the cassette type detector 1, sometimes, it would be impossible for the concerned user to determine whether or not the cassette type detector 1 is normally operable. For instance, even if a part of the detecting section 212 has been damaged due to the unexpected impact, when the electrical failure or malfunction cannot be found in the cassette type detector 1 as a whole, it is possible for the user to conduct the operation for detecting the radiation image, and therefore, despite that the part of the detecting section 212 does not normally function, the user would continuously implements the detecting operation without recognizing the damage of the detecting section 212.

Further, for instance, in such a case that an accumulated number of unexpected impacts, which have been applied to the cassette type detector 1, (for instance, a number of dropping accidents), is designated (specified) by the manufacturer from its durability point of view, when the system is so constituted that the number of unexpected impacts applied to the cassette type detector 1 is artificially controlled, it is impossible to control the history of the unexpected impacts more accurately than ever, due to forgetting records, etc.

To cope with the abovementioned problem, the cassette type detector 1 is so constituted that it is provided with a unit for detecting a received impact, so as to determine whether or not the cassette type detector 1 is out of order based on the degrees and the accumulated number of the received impacts detected by the unit concerned.

FIG. 8 shows a block diagram indicating a configuration in regard to the operations for detecting the impact to be applied to the cassette type detector 1 so as to recognize the malfunction thereof.

A control section 101 is constituted by, for instance, a CPU (Central Processing Unit), etc., so that the CPU reads out a controlling program stored in the ROM (Read Only Memory) 102 to develop the controlling program onto a working area provided within a RAM (Random Access Memory 103, and executes the controlling program developed, so as to control various kinds of sections included in the cassette type detector 1.

The ROM 102 is constituted by a nonvolatile semiconductor storage device, etc., so as to store the controlling program and various kinds of programs, etc., therein.

The RAM 103 forms a working area into which various kinds of programs read from the ROM 102 and being implementable by the control section 101 in the various kinds of processing to be controlled and implemented by the control section 101, input/output data, and various kinds of parameters, are temporarily stored.

A storage section 104 is constituted by a nonvolatile storage device and a RAM (Random Access Memory) for instance, a flash memory, etc., so as to store the accumulated number of the impacts detected by an acceleration sensor 107, therein.

A power source section 105 supplies an electric power to the control section 101, the acceleration sensor 107, etc. In the normal operating state, the power source section 105 supplies the electric power to the various kinds of sections, while, in the event that the power source section 105 is turned OFF, a sub power source section 106 supplies the electric power to the control section 101, the acceleration sensor 107, etc.

For instance, the acceleration sensor 107 is either a two axes-type sensor that detects accelerations in directions of an X axis and a Y axis, respectively, or a three axes-type sensor that detects accelerations in directions of an X axis, a Y axis and a Z axis, respectively. Based on the waveform of the output signal outputted by the acceleration sensor 107, it is possible to detect the fact that an impact is incurred to the cassette type detector 1. Concretely speaking, unless a strong impact is applied to the cassette type detector 1, the peak value of the output waveform outputted by the acceleration sensor 107 is kept low. However, since the peak value of the output waveform outputted by the acceleration sensor 107 becomes high when the strong impact is applied to the cassette type detector 1, by detecting the change of the peak value abovementioned, it is possible to detect the fact that a considerable impact is incurred to the cassette type detector 1. Accordingly, for instance, the control section 101 counts a number of events in each of which the peak value of the output waveform has exceeded a reference value and stores the above-counted number of events into the storage section 104. In this connection, the acceleration sensor 107 is disposed at a position being near the center position of the cassette type detector 1.

Next, concrete operations to be conducted in the cassette type detector 1, based on the operation for detecting the impact, will be detailed in the following.

When the power source section 105 of the cassette type detector 1 is turned ON, the control section 101 checks the accumulated number of the impacts (history information stored in the storage section 104. When determining that the accumulated number concerned is smaller than a predetermined criterion number, the control section 101 makes the power source section 105 keep the power ON state as it is. On the other hand, when determining that the accumulated number concerned is equal to or greater than the predetermined criterion number, since the possibility that the cassette type detector 1 have gotten into the malfunction state is high, the control section 101 turns a color of light, which is to be emitted by the indicator 53, to a warning color, makes an apparatus, currently communicating through the wireless communicating section 4, display a warning message, and so on, and then, turns OFF the electric power to be supplied from the power source section 105.

In the state that the power source section 105 of the cassette type detector 1 is turned ON, the control section 101 monitors the waveform of the signal outputted by the acceleration sensor 107. When grasping that the peak value of the waveform concerned is equal to or greater than a first criterion value, the control section 101 determines that a considerably strong impact is applied to the cassette type detector 1, and, since the possibility that the cassette type detector 1 have gotten into the malfunction state is high, the control section 101 turns a color of light, which is to be emitted by the indicator 53, to a warning color, and makes an apparatus, currently communicating through the wireless communicating section 4, display a warning message, so on, and turns OFF the electric power to be supplied from the power source section 105. Alternatively, when grasping that the peak value of the waveform concerned is equal to or greater than the first criterion value, the control section 101 implements a self-examination process of the cassette type detector 1 so as to find a malfunctioned part, and, if a malfunction is found at a certain part of the cassette type detector 1 as a result of implementing the self-examination process, the control section 101 turns a color of light, which is to be emitted by the indicator 53, to a warning color, and makes an apparatus, currently communicating through the wireless communicating section 4, display a warning message, and so on, and then, turns OFF the electric power to be supplied from the power source section 105. On the other hand, when no malfunction is found, the control section 101 makes the power source section 105 keep ON state as it is.

When grasping that the peak value of the waveform of the output signal outputted by the acceleration sensor 107 is smaller than the first criterion value and greater than a second criterion value, the control section 101 adds “1” to the accumulated number of the impacts applied to the cassette type detector 1 so as to update the accumulated number concerned. Further, when determining that the accumulated number above-updated is smaller than the predetermined criterion number, since the possibility that the cassette type detector 1 have gotten into the malfunction state is low, the control section 101 makes the power source section 105 keep the power ON state as it is, while, when determining that the accumulated number above-updated is equal to or greater than the predetermined criterion number, since the possibility that the cassette type detector 1 have gotten into the malfunction state is high, the control section 101 turns a color of light, which is to be emitted by the indicator 53, to a warning color, makes an apparatus, currently communicating through the wireless communicating section 4, display a warning message, and so on, and then, turns OFF the electric power to be supplied from the power source section 105.

In this connection, even when the electric power to be supplied from the power source section 105 is turned OFF, the sub power source section 106 supplies the electric power to the acceleration sensor 107, etc., so that the control section 101 can continuously monitor the waveform of the output signal outputted by the acceleration sensor 107. In other words, the waveform of the output signal outputted by the acceleration sensor 107 is always monitored, so as to detect and manage the impact applied to the cassette type detector 1 on a steady basis.

As described in the foregoing, by installing the unit for detecting the received impact into the cassette type detector 1, and by determining whether or not the cassette type detector 1 is out of order based on the degrees and the accumulated number of the received impacts detected by the unit concerned, it becomes possible to notify the user of the fact that the cassette type detector 1 is currently out of order, in order to prevent the user from implementing an unnecessary radiation image detecting operation.

According to a radiation image detecting cassette embodied in the present invention, it becomes possible to continuously conduct operations for detecting appropriate radiation images without making the glass substrate fall into the breakage failure.

1-4. (canceled)

5. A radiation image detecting cassette that detects radiation irradiated onto a subject to acquire radiation image data, and that is formed as a portable-type cassette, comprising:
a detecting section to detects radiation being incident thereon, so as to output electric signals corresponding to incident radiation detected;
a glass base plate onto which the detecting section is installed;
a substrate to support the glass base plate;
a housing that incorporates at least the detecting section, the glass base plate and the substrate, therein; and
a buffer member that is installed between an end portion of the substrate and an inner wall of the housing;
wherein a side wall is formed at the end portion of the substrate, and the glass base plate is supported by the substrate in such a state that the glass base plate is adhered onto the substrate; and
wherein a gap is provided between an end portion of the glass base plate and the side wall.

6. The radiation image detecting cassette of claim 5,
wherein a width of the gap is set at 1 mm.

7. The radiation image detecting cassette of claim 5,
wherein a buffer member is inserted between the glass base plate and the substrate.

8. The radiation image detecting cassette of claim 5,
wherein, when it is defined that an outer-shape length of the housing is “A” and a detecting-region length of the radiation image detecting cassette in the same direction of the concerned outer-shape length is “B”, a value of B/A is in a range of 0.85-0.95.
